(19) United States
(12) Patent Application Publication
(10) Pub. No.: US 2014/0013216 A1
(43) Pub. Date: Jan. 9, 2014

(54) DISPLAY CONTROL DEVICE, DISPLAY METHOD, CONTROL PROGRAM, AND RECORDING MEDIUM

(71) Applicant: Makoto Sakuta, Osaka-shi (JP)

(72) Inventor: Makoto Sakuta, Osaka-shi (JP)

(73) Assignee: Sharp Kabushiki Kaisha, Osaka-shi, OSAKA (JP)

(21) Appl. No.: 14/005,035

(22) PCT Filed: May 28, 2012
(86) PCT No.: PCT/JP2012/063660

§ 371 Date: Sep. 13, 2013

(30) Foreign Application Priority Data
Nov. 24, 2011 (JP) 2011-256687

(51) Int. Cl. G06F 17/21

(52) U.S. Cl. CPC G06F 17/212
USPC 715/252

(57) ABSTRACT

An electronic book reader (1) includes: an enlargement region determining section (20) which (i) refers to line management information (30) so as to determine, by assuming that a specified position on content (31) is a reference, an enlargement region in a line including the position and (ii) further determines, in a subsequent line, an enlargement region within a region that can be displayed in an enlarged manner in the line display area; and a display processing section (21) which displays enlarged images of the respective determined enlargement regions in the line display area so that the enlarged image corresponding to the line including the position and the enlarged image corresponding to the subsequent line are arranged in this order.

### TECHNICAL FIELD

The present invention relates to a technique for displaying document content in an enlarged manner, more specifically a display control device or the like for displaying page layout-type document content in an enlarged manner.

### BACKGROUND ART

In recent years, use of document content, such as an electronic book, which is in the form of electronic data is widely spreading. The document content which is generally used can be classified into reflow-type document content and page layout-type document content.

The page layout-type document content is document content whose layout is fixed. The page layout-type document content has an advantage that the layout of the document content does not lose its shape even in a case where the document content is displayed in an enlarged manner. Another advantage of the page layout-type document content is that the document content can be created easily by reading a paper document by means of a scanner or the like. On the other hand, the page layout-type document content has an advantage that, in a case where a part of a document does not fit in a screen because the document is displayed in an enlarged manner, it is necessary to repeat scrolling in order to read through a text.

By contrast, the reflow-type document content is document content which is created on the assumption that a display size of the document content is variable. In a case where the display size of the reflow-type document content is changed, characters reflow in accordance with the display size thus changed. As such, even in a state where the reflow-type document content is displayed in an enlarged manner, it is possible to read through a text by simply feeding pages without the need to repeat scrolling, unlike in the case of the page layout-type document content. On the other hand, the reflow-type document content has a disadvantage of having the need to manage the document content on a character-by-character basis, and thus requiring more operations and costs for creating content as compared with the page layout-type document content.

Techniques for addressing the above-described disadvantage of the page layout-type document content are disclosed in documents including Patent Literatures 1 and 2 as listed below. Patent Literature 1 describes dividing an enlarged image into two parts which are displayed in respective two columns, and thus preventing the image from partially not being displayed when displayed in an enlarged manner. Patent Literature 2 describes that each part that is included in a document and corresponds to a word is recognized as an object, and an arrangement of the object is changed in accordance with a display size, so that the page layout-type document content is displayed in a similar manner as the reflow-type document content.

As described above, the page layout-type document content has an advantage of having a fixed layout. As such, if a configuration is realized in which a document having a fixed layout is displayed while a part of the document is displayed in an enlarged manner in the same screen, the configuration will be convenient for a user because it allows the user to enlarge and view part, which is difficult to read, of characters or text of a page, while the user checks the layout of the page.

Techniques related to this include Patent Literature 3 as listed below. Patent Literature 3 describes that a headword that is selected among headwords displayed in a list is displayed in an enlarged manner in a zoom window.

### CITATION LIST

### Patent Literatures

Patent Literature 1
Japanese Patent Application Publication, Tokukai, No. 2007-226213 A (Publication Date: Sep. 6, 2007)
Patent Literature 2
Japanese Translation of PCT International Publication, Tokuhyo, No. 2009-531789 A (Publication Date: Sep. 3, 2009)
Patent Literature 3
Japanese Patent Application Publication, Tokukai, No. 2006-331443 A (Publication Date: Dec. 7, 2006)

### SUMMARY OF INVENTION

### Technical Problem

However, conventional techniques as described above have a problem that, in a case where a region to be enlarged extend over a plurality of lines, the region cannot be easily specified and displayed in an enlarged manner. The techniques disclosed in Patent Literatures 1 and 2 each assume a case in which a region to be enlarged is displayed in an enlarged manner throughout a screen, and thus do not take account of a case in which an image which has not been enlarged is displayed in an area of a screen while a part of the image is displayed in an enlarged manner in another area of the same screen. The technique disclosed in Patent Literature 3 is for displaying a headword in an enlarged manner, and a headword usually never extends over a plurality of lines when displayed. Therefore, it is difficult to address the problem by combining the techniques of these documents.

The present invention is accomplished in view of the problem. An object of the present invention is to provide a display control device or the like which allows a region of document content, which region extends over a plurality of lines, to be easily specified and displayed in an enlarged manner.

### Solution to Problem

In order to attain the object, a display control device of the present invention is a display control device which displays document content made up of a plurality of lines and displays a section of the plurality of lines of the document content in an enlarged manner in a predetermined enlarged-display area, including: enlargement region determining means for (i) referring to management information indicative of positions of the respective plurality of lines so as to determine, by assuming that a position specified on the document content is a reference, a region in a line including the position, the region serving as an enlargement region, and (ii), in a case where the enlargement region thus determined reaches an end of the line, further determining, as an extension of the enlargement region, a region in a subsequent line which region starts at a head of the subsequent line and fits in the enlarged-display area when displayed in an enlarged manner in the enlarged-display area; and enlarged display means for displaying an enlarged image of the enlargement region, which has been determined by the enlargement region determining means, in the enlarged-display area so that a part of the enlarged image which corresponds to the line including the position and a part of the enlarged image which corresponds to the subsequent line are arranged in this order.

Further, in order to attain the object, a display method of the present invention is a display method carried out by a display control device which displays document content made up of a plurality of lines and displays a section of the plurality of lines of the document content in an enlarged manner in a predetermined enlarged-display area, the method including the steps of: (i) referring to management information indicative of positions of the respective plurality of lines so as to determine, by assuming that a position specified on the document content is a reference, a region in a line including the position, the region serving as an enlargement region; (ii) in a case where the enlargement region thus determined reaches an end of the line, further determining, as an extension of the enlargement region, a region in a subsequent line which region starts at a head of the subsequent line and fits in the enlarged-display area when displayed in an enlarged manner in the enlarged-display area; and (iii) displaying an enlarged image of the enlargement region, which has been determined, in the enlarged-display area so that a part of the enlarged image which corresponds to the line including the position and a part of the enlarged image which corresponds to the subsequent line are arranged in this order.

According to the configuration, a region in a line including a position specified on the document content, which region serves as an enlargement region, is determined by referring to the management information and assuming that the position is a reference. Further, in a case where the enlargement region thus determined reaches an end of the line including the position, a region is further determined, as an extension of the enlargement region, in a subsequent line which region starts at a head of the subsequent line and fits in the enlarged-display area when displayed in an enlarged manner in the enlarged-display area. Then, an enlarged image of the enlargement region, which has been determined, is displayed in the enlarged-display area so that a part of the enlarged image which corresponds to the line including the position and a part of the enlarged image which corresponds to the subsequent line are arranged in this order.

That is, according to the configuration, the enlargement region is displayed so that the line including the position which has been specified is connected with the subsequent line. That is, the configuration allows the user to easily specify, in the document content, a region which extends over a plurality of lines and display the specified region in an enlarged manner.

Further, in order to attain the object, another display control device of the present invention is a display control device which displays document content made up of a plurality of columns and displays a section of the plurality of columns of the document content in an enlarged manner in a predetermined enlarged-display area, including: enlargement region determining means for (i) referring to management information indicative of positions of the respective plurality of columns so as to determine, by assuming that a position specified on the document content is a reference, a region in a column including the position, the region serving as an enlargement region, and (ii), in a case where the enlargement region thus determined reaches an end of the column, further determining, as an extension of the enlargement region, a region in a subsequent column which region starts at a head of the subsequent column and fits in the enlarged-display area when displayed in an enlarged manner in the enlarged-display area; and enlarged display means for displaying an enlarged image of the enlargement region, which has been determined by the enlargement region determining means, in the enlarged-display area so that a part of the enlarged image which corresponds to the column including the position and a part of the enlarged image which corresponds to the subsequent column are arranged in this order.

Further, in order to attain the object, another display method of the present invention is a display method carried out by a display control device which displays document content made up of a plurality of columns and displays a section of the plurality of columns of the document content in an enlarged manner in a predetermined enlarged-display area, the method including the steps of: (i) referring to management information indicative of positions of the respective plurality of columns so as to determine, by assuming that a position specified on the document content is a reference, a region in a column including the position, the region serving as an enlargement region; (ii) in a case where the enlargement region thus determined reaches an end of the column, further determining, as an extension of the enlargement region, a region in a subsequent column which region starts at a head of the subsequent column and fits in the enlarged-display area when displayed in an enlarged manner in the enlarged-display area; and (iii) displaying an enlarged image of the enlargement region, which has been determined, in the enlarged-display area so that a part of the enlarged image which corresponds to the column including the position and a part of the enlarged image which corresponds to the subsequent column are arranged in this order.

According to the configuration, a region in a column including a position specified on the document content, which region serves as an enlargement region, is determined by referring to the management information and assuming that the position is a reference. Further, in a case where the enlargement region thus determined reaches an end of the column including the position, a region is further determined, as an extension of the enlargement region, in a subsequent column which region starts at a head of the subsequent column and fits in the enlarged-display area when displayed in an enlarged manner in the enlarged-display area. Then, an enlarged image of the enlargement region, which has been determined, is displayed in the enlarged-display area so that a part of the enlarged image which corresponds to the column including the position and a part of the enlarged image which corresponds to the subsequent column are arranged in this order.

That is, according to the configuration, the enlargement region is displayed so that the column including the position which has been specified is connected with the subsequent column. That is, the configuration allows the user to easily specify, in the document content, a region which extends over a plurality of columns and display the specified region in an enlarged manner.

### Advantageous Effects of Invention

As described above, the display control device of the present invention includes: the enlargement region determining means for (i) referring to the management information indicative of the positions of the respective plurality of lines so as to determine, by assuming that a position specified on the document content is a reference, a region in a line including the position, the region serving as an enlargement region, and (ii), in a case where the enlargement region thus determined reaches an end of the line, further determining, as an extension of the enlargement region, a region in a subsequent line which region starts at a head of the subsequent line and fits in the enlarged-display area when displayed in an enlarged manner in the enlarged-display area; and the enlarged display means for displaying an enlarged image of the enlargement region, which has been determined by the enlargement region determining means, in the enlarged-display area so that a part of the enlarged image which corresponds to the line including the position and a part of the enlarged image which corresponds to the subsequent line are arranged in this order.

Further, the display method of the present invention includes the steps of: (i) referring to the management information indicative of the positions of the respective plurality of lines so as to determine, by assuming that a position specified on the document content is a reference, a region in a line including the position, the region serving as an enlargement region; (ii) in a case where the enlargement region thus determined reaches an end of the line, further determining, as an extension of the enlargement region, a region in a subsequent line which region starts at a head of the subsequent line and fits in the enlarged-display area when displayed in an enlarged manner in the enlarged-display area; and (iii) displaying an enlarged image of the enlargement region, which has been determined, in the enlarged-display area so that a part of the enlarged image which corresponds to the line including the position and a part of the enlarged image which corresponds to the subsequent line are arranged in this order.

According to the configuration, the enlargement region is displayed so that the line including the position which has been specified is connected with the subsequent line. This provides an advantageous effect that the user can easily specify, in the document content, a region which extends over a plurality of lines and display the specified region in an enlarged manner.

As described above, the another display control device of the present invention includes: the enlargement region determining means for (i) referring to the management information indicative of the positions of the respective plurality of columns so as to determine, by assuming that a position specified on the document content is a reference, a region in a column including the position, the region serving as an enlargement region, and (ii), in a case where the enlargement region thus determined reaches an end of the column, further determining, as an extension of the enlargement region, a region in a subsequent column which region starts at a head of the subsequent column and fits in the enlarged-display area when displayed in an enlarged manner in the enlarged-display area; and the enlarged display means for displaying an enlarged image of the enlargement region, which has been determined by the enlargement region determining means, in the enlarged-display area so that a part of the enlarged image which corresponds to the column including the position and a part of the enlarged image which corresponds to the subsequent column are arranged in this order.

Further, the another display method of the present invention includes the steps of: (i) referring to the management information indicative of the positions of the respective plurality of columns so as to determine, by assuming that a position specified on the document content is a reference, a region in a column including the position, the region serving as an enlargement region; (ii) in a case where the enlargement region thus determined reaches an end of the column, further determining, as an extension of the enlargement region, a region in a subsequent column which region starts at a head of the subsequent column and fits in the enlarged-display area when displayed in an enlarged manner in the enlarged-display area; and (iii) displaying an enlarged image of the enlargement region, which has been determined, in the enlarged-display area so that a part of the enlarged image which corresponds to the column including the position and a part of the enlarged image which corresponds to the subsequent column are arranged in this order.

According to the configuration, the enlargement region is displayed so that the column including the position which has been specified is connected with the subsequent column. This provides an advantageous effect that the user can easily specify, in the document content, a region which extends over a plurality of columns and display the specified region in an enlarged manner.

### BRIEF DESCRIPTION OF DRAWINGS

FIG. 1 is a view illustrating an embodiment of the present invention, and is a block diagram illustrating a configuration of main parts of an electronic book reader.

FIG. 2 is a view illustrating an example of a displayed screen in a page viewing mode and an example of a displayed screen in a line viewing mode. (a) of FIG. 2 illustrates an example of a screen in the page viewing mode, and (b) of FIG. 2 illustrates an example of a screen in the line viewing mode.

FIG. 3 is a view illustrating a method for operating the electronic book reader in the line viewing mode.

FIG. 4 is a view illustrating an example of a screen in which vertically written document content is displayed by the electronic book reader in a line viewing mode.

FIG. 5 is a view illustrating an example of display in a column viewing mode, which is one of the viewing modes of the electronic book reader.

FIG. 6 is a view illustrating an example of a screen into which a transition has been made from the column viewing mode. (a) of FIG. 6 is an example of display in a column full-screen mode, and (b) of FIG. 6 is an example of display in a page full-screen mode.

FIG. 7 is a view illustrating an example of a screen in which a note is displayed by the electronic book reader as related information.

FIG. 8 is a view illustrating an example of a screen in which a drawing is displayed by the electronic book reader as related information.

FIG. 9 is a view illustrating a screen transition which is made when related information is displayed by the electronic book reader. (a) of FIG. 9 illustrates an example of a screen in a state before the related information is displayed, and (b) of FIG. 9 illustrates an example of a screen in a state after a drawing is displayed as the related information.

FIG. 10 is a view illustrating line management information which is used by the electronic book reader for enlarged display or the like.

FIG. 11 is a view illustrating the related information position list which is used by the electronic book reader to display related information.

FIG. 12 is a flowchart showing an example of an enlarged display process carried out when the electronic book reader carries out enlarged display.

FIG. 13 is a flowchart showing an example of a during-enlargement process which is carried out by the electronic book reader during an enlarged display.

FIG. 14 is a flowchart showing an example of a related information display process in which the electronic book reader displays content of a drawing, content of a note, or the like during an enlarged display.

### DESCRIPTION OF EMBODIMENTS

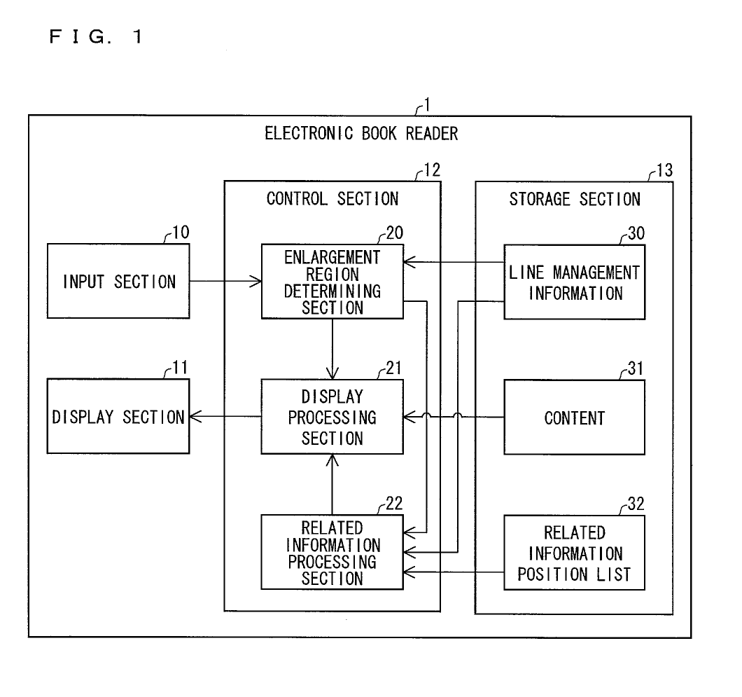

The following description will discuss details of an embodiment of the present invention with reference to FIGS. 1 through 14.

[Configuration of Electronic Book Reader]

First, the following description will discuss, with reference to FIG. 1, an electronic book reader in accordance with the present embodiment. FIG. 1 is a block diagram illustrating a configuration of main parts of an electronic book reader (display control device) 1. As illustrated in FIG. 1, the electronic book reader 1 includes an input section 10, a display section 11, a control section 12, and a storage section 13.

The electronic book reader 1 is an electronic device which allows a user to view document content such as an electronic book. For example, the electronic book reader 1 displays page layout-type document content such as PDF (Portable Document Format). A main feature of the electronic book reader 1 resides in how document content is displayed in an enlarged manner. Note that document content to be displayed is not limited to one in the PDF format, and may be one in other formats such as TIFF and JPEG.

The input section 10 receives an input operation given by the user of the electronic book reader 1, and transmits the input operation to the control section 12. The display section 11 is controlled by the control section to display an image. The following description will discuss an example in which the input section 10 and the display section 11 are implemented as a touch panel. Note that the input section 10 and the display section 11 may be a device which is provided independent of and external to the electronic book reader 1.

The control section 12 controls functions of the electronic book reader 1 as a whole, and includes an enlargement region determining section (enlargement region determining means) 20, a display processing section (enlarged display means) 21, and a related information processing section (related information processing means) 22.

The enlargement region determining section 20 determines, on the basis of the input operation received by the input section 10, an enlargement region of an image which is currently displayed. Specifically, when the input section 10 receives an input operation that selects a position on document content which is currently displayed, the enlargement region determining section 20 determines an enlargement region while assuming the selected position as a reference. Note that details of how to determine the enlargement region will be described later.

The display processing section 21 carries out a process of causing the display section 11 to display the document content, as well as a process of enlarging, reducing, or scrolling the displayed document content. The display processing section 21 displays the document content on the display section 11 in a viewing mode in accordance with a document to be displayed on the display processing section 21. The viewing mode includes (i) a page viewing mode in which the document is displayed page by page, (ii) a line viewing mode in which an enlarged part of the document is displayed line by line, and (ii) a column viewing mode in which an enlarged part of the document is displayed column by column. Details of the viewing modes will be described later.

The related information processing section 22 carries out a process of displaying related information of the document content. Specifically, the related information processing section 22 causes a note and a drawing, each of which corresponds to the enlargement region among notes and drawings included in the document content, to be displayed automatically or in response to a user' operation. Details of the process of displaying the related information will be also described later.

The storage section 13 stores various data used by the electronic book reader 1. The storage section 13 stores line management information (management information, link information) 30, content (document content) 31, and a related information position list (image position information) 32.

Note that, although the present embodiment describes an example in which the storage section 13 is built in the electronic book reader 1, the present embodiment is not limited to the example, as long as the data stored in the storage section 13 may be read out by the electronic book reader 1. For example, the storage section 13 may be provided external to the electronic book reader 1, or be present in a server or the like which is capable of communicating with the electronic book reader 1.

The line management information 30 is used to manage document content, and includes at least information that indicates positions of the lines constituting the document content or positions of columns constituting the document content. The enlargement region determining section 20 determines the enlargement region with use of the line management information 30.

The line management information 30 also includes information for specifying related information of a line. That is, the line management information 30 includes the link information which links a line and related information. Note that details of content of the line management information 30, determination of the enlargement region on the basis of the line management information 30, and the like will be described later.

The content 31 is an object to be displayed on the display section 11. The following description will discuss an example in which the content 31 is document content in the PDF format. Note that the content 31 is not limited to one in the PDF format, as long as it is page layout-type document content.

The related information position list (image position information) 32 is a list which indicates a position in the document content where a related image corresponding to the related information is included. The related image is, for example, an image of a note or a drawing. The related information processing section 22 causes the related information to be displayed with use of the line management information 30 and the related information position list 32. Note that details of content of the related information position list 32, display of the related information on the basis of the related information position list 32, and the like will be described later.

[Display in Page Viewing Mode and Display in Line Viewing Mode]

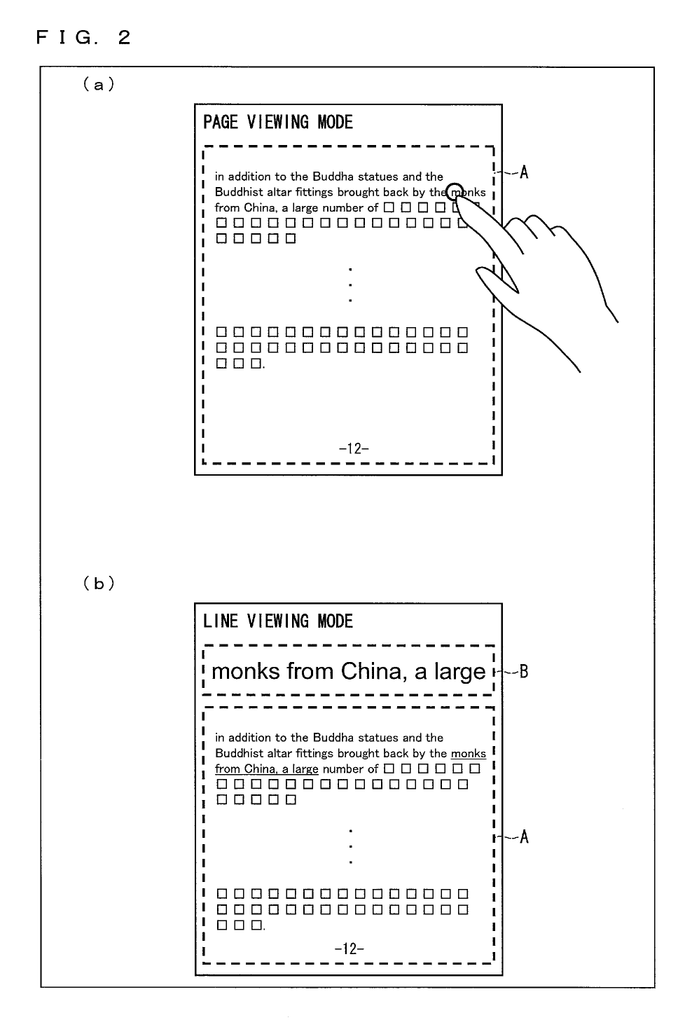

Next, the following description will discuss, with reference to FIG. 2, display in the page viewing mode and display in the line viewing mode. FIG. 2 is a view illustrating an example of a displayed screen in the page viewing mode and an example of a displayed screen in the line viewing mode. (a) of FIG. 2 illustrates an example of a screen in the page viewing mode, and (b) of FIG. 2 illustrates an example of a screen in the line viewing mode.

As illustrated in (a) of FIG. 2, the document content is displayed in a page display area A in the page viewing mode. In the page display area A, basically a single page of the document content is displayed. The user taps (touches with a finger or the like for a short time), in the page display area A, a position to be displayed in an enlarged manner. This causes a transition to the line viewing mode. Note that an operation of specifying an enlarged position is not limited to tapping, and may be such operations as double tapping (i.e., tapping the same position twice in a row) or press-and-holding (i.e., touching the same position for a predetermined time or longer).

In the line viewing mode, a line display area (enlarged-display area) B appears as illustrated in (b) of FIG. 2. A part of the document displayed in the page display area A is displayed in the line display area B in an enlarged manner. In response to the appearance of the line display area B, the page display area A is reduced.

Note that it is preferable that the single page be displayed in its entirety also in the reduced page display area A. This makes it possible to read enlarged letters while checking a layout of the entire page. As a matter of course, in a case where there is a space for the line display area B, it is unnecessary to reduce the page display area A.

In the example illustrated in FIG. 2, a length direction of the line display area B corresponds to a lateral direction, since the document which is displayed is laterally written. Out of the document displayed in the displayed page display area A, a part which starts at “monks” and ends at “, and a large” is displayed in the line display area B in an enlarged manner.

The part starting at “monks” and ending at “, and a large” in the page display area A extends from the first line to the second line of text. That is, the electronic book reader 1 is characterized in that, even though an object to be displayed is page layout-type document content, a region which extends, relative to a specified position as a reference, over a plurality of lines can be displayed in an enlarged manner.

Further, the enlargement region is underlined in the page display area A. Underlining the enlargement region in this manner allows the user to be understand where the enlargement region is located in the layout of the entire page. Note that this effect can be obtained by displaying the enlargement region so that the enlargement region is distinguishable from the other part of the image of the entire page. Accordingly, the effect can also be obtained by displaying the enlargement region, for example, with a background color that is different from that of the other part.

[Operation Method in Line Viewing Mode]

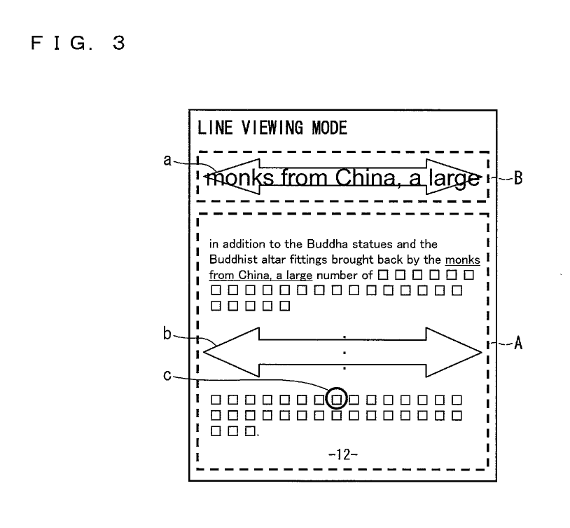

Next, an operation method in the line viewing mode will be described with reference to FIG. 3. FIG. 3 is a view illustrating an operation method in the line viewing mode.

As illustrated in FIG. 3, the screen for the line viewing mode includes the page display area A and the line display area B. By carrying out a dragging operation (an operation of sliding a finger that is touching a display surface) in a horizontal direction, as indicated by an arrow a, in the line display area B, it is possible to scroll through the enlargement region. Specifically, dragging leftward allows text that follows “, a large” (text starting at “number of” to be displayed in an enlarged manner. Similarly, dragging rightward allows text that precedes “monks” to be displayed in an enlarged manner.

That is, a dragging operation in the horizontal direction in the line display area B makes it possible to read through enlarged text. As described above, the electronic book reader 1 makes it possible to view page layout-type document content by reflowing the document content.

It is also possible to carry out line feed by carrying out a flicking operation (an operation of sliding a finger, which is touching the display surface, so as to separate the finger away from the display surface) in the horizontal direction in the line display area B. Note that “line feed” in this description denotes displaying, instead of the part displayed in the line display area B, a part that follows or precedes said part. That is, “line feed” means changing from a part displayed in an enlarged manner to another part that precedes or follows said part. For example, in a case where a rightward flicking operation is carried out in the example shown in FIG. 3, a part which starts at “fittings” and ends at “by the” is displayed in the line display area B.

Further, although not shown in FIG. 3, it is possible to employ a configuration in which zooming can be changed by carrying out an operation such as pinching out (an operation of spreading a gap between two fingers while the two fingers are in contact with the display surface) or pinching in (an operation of reducing a gap between two fingers while the two fingers are in contact with the display surface) in the line display area B.

On the other hand, a flicking operation (an operation indicated by an arrow b in FIG. 3) in the horizontal direction in the page display area A corresponds to page switching. That is, in a case where a rightward flicking operation is carried out in the page display area A, a page that precedes a currently displayed page is displayed. Likewise, in a case where a leftward flicking operation is carried out, a page that follows a currently displayed page is displayed. Thus, a processed carried out in response to a flicking operation in the horizontal direction varies in a case where the flicking operation is carried out in the page display area A and in a case where the flicking operation is carried out in the line display area B.

Further, by carrying out a tapping operation in the page display area A, it is possible to re-specify a region to be displayed in an enlarged manner. For example, carrying out a tapping operation in a position indicated by c in FIG. 3 causes an enlargement region to be set again while assuming the position as a reference, so that the image displayed in the line display area B is updated.

Note that operations carried out in the page viewing mode are the same as those carried out in the page display area A in the line viewing mode. That is, in the page viewing mode, page switching is carried out by a flicking operation in the horizontal direction. Further, a specification of an enlargement region by a tapping operation is received, so that a transition to the line viewing mode is made.

[Display in Line Viewing Mode (vertical writing)]

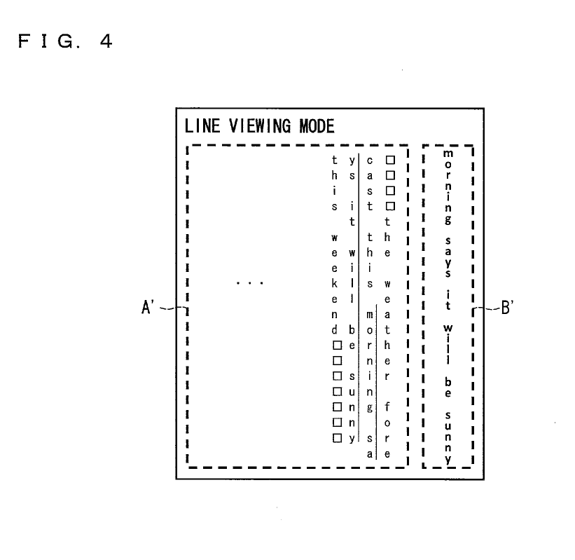

FIGS. 2 and 3 each illustrate an example in which horizontally written document content is displayed in the line viewing mode. In a case where a document is written vertically, on the other hand, the document is displayed in a layout that is different from a layout in a case where a document is vertically written. This will be further described with reference to FIG. 4. FIG. 4 is a view illustrating an example of a screen in which vertically written document content is displayed in the line viewing mode.

As illustrated in FIG. 4, in a case where vertically written document content is displayed in an enlarged manner, a line display area (enlarged-display area) B′, a length direction of which corresponds to a vertical direction, appears so as to be adjacent to a page display area A′ in a horizontal direction. Also in a case where the vertically written document content is displayed in an enlarged manner, a part that extends over a plurality of lines is displayed in an enlarged manner, as in the case where horizontally written document content is displayed in an enlarged manner. Specifically, a region to be enlarged starts at “morning” in the second line and ends at “sunny” in the third line in the page display area A′, and is displayed in the line display area B′ in an enlarged manner.

Further, operations carried out in the case where the vertically written document content is displayed in an enlarged manner are also similar to those carried out as illustrated in FIG. 3, except that, since the line display area B′ employs vertical writing, scrolling is carried out by a dragging operation in the vertical direction and line feed is carried out by a flicking operation in the vertical direction, unlike in the case where horizontally written document content is displayed in an enlarged manner.

[Display in Column Viewing Mode]

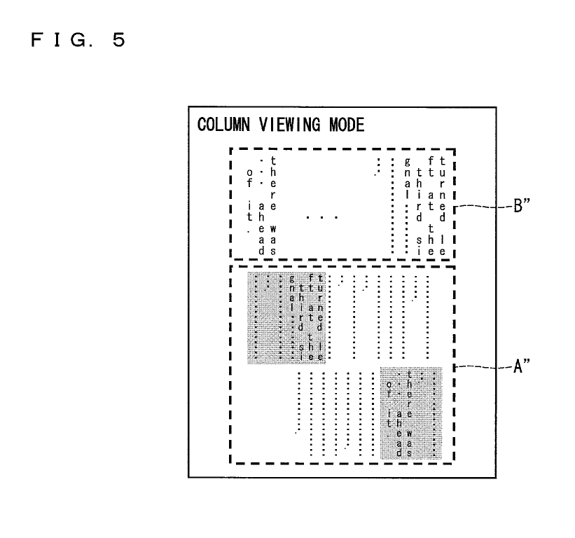

Upon reception of a specification (a tapping operation on a page display area) of an enlargement region in a case where document content is made up of columns, the electronic book reader 1 makes a transition to the column viewing mode so as to display a column in an enlarged manner. The following description will discuss, with reference to FIG. 5, display in the column viewing mode. FIG. 5 is a view illustrating an example of display in the column viewing mode.

As illustrated in FIG. 5, a screen in the column viewing mode includes a page display area A″ and a column display area (enlarged-display area) B″. Text that starts at “turned” in the first column and ends at “ahead of it.” is displayed in the column display area B″.

As in the examples illustrated in FIGS. 2 through 4, a single page is displayed in its entirety in the page display area A″, and a part starting at “turned” in the first column and ending at “ahead of it.” in the second column is marked. Thus, in the column viewing mode, a region that extends over a plurality of columns in the page display area A″ is displayed in the column display area B″ in an enlarged manner.

Also in the column viewing mode, operations as illustrated in FIG. 3 can be carried out as in the line viewing mode. For example, it is possible to carry out (i) a dragging operation in the horizontal direction in the column display area B″ so as to scroll through an enlargement region, (ii) a tapping operation in the region page display area A″ so as to specify an enlargement region, and (iii) other operations.

[Display Switching from Column Viewing Mode]

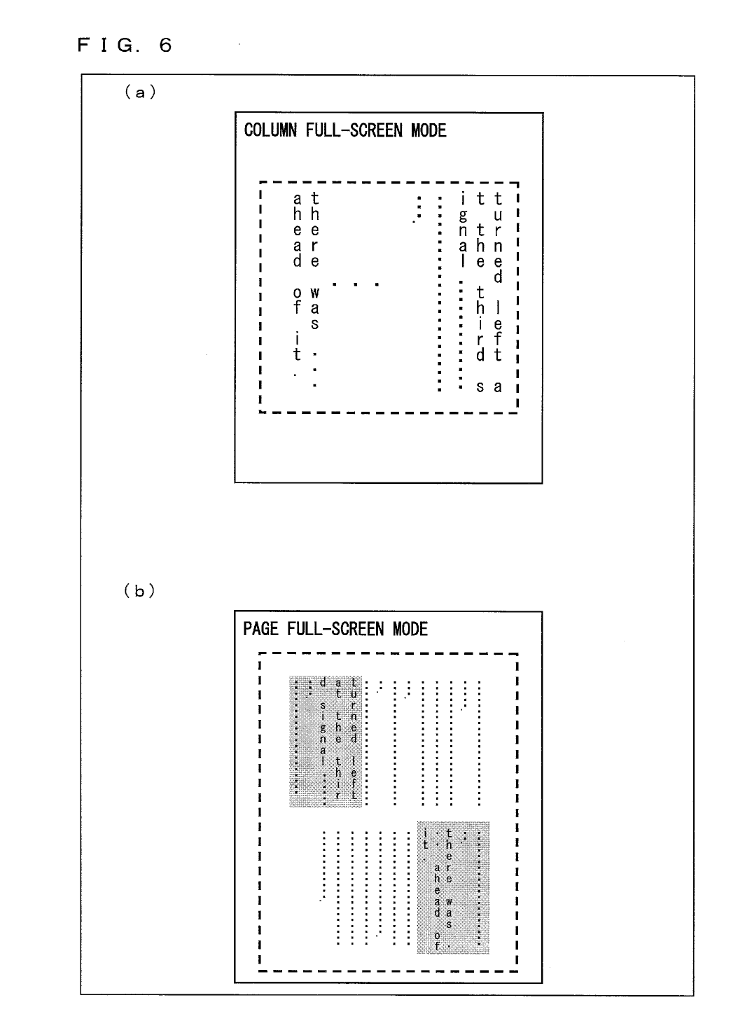

In the column viewing mode, the number of letters included in an enlargement region is greater than that in the line viewing mode. As such, there is a possibility that the enlargement region cannot be enlarged sufficiently, depending on a screen size of the display section 11. In view of this, in the column viewing mode, it is possible to carry out display switching for displaying the enlargement region in a larger size. The following description will discuss, with reference to FIG. 6, display switching from the column viewing mode. FIG. 6 is a view illustrating an example of a screen into which a transition has been made from the column viewing mode. (a) of FIG. 6 is an example of display in a column full-screen mode, and (b) of FIG. 6 is an example of display in a page full-screen mode.

In the column full-screen mode as illustrated in (a) of FIG. 6, the column display area B″ is displayed throughout the screen, so that zooming is increased as compared with the example of the screen as illustrated in FIG. 5. Accordingly, the column full-screen mode has an increased visibility of letters as compared with the column viewing mode and the page viewing mode.

Further, in the column full-screen mode, it is possible to carry out operations similar to those carried out in the column display area B″ in the column viewing mode. That is, in the column full-screen mode, it is possible to carry out (i) a dragging operation in the horizontal direction so as to scroll through an enlargement region, (ii) a flicking operation so as to cause a position of an enlargement region to move, and (iii) other operations.

In the page full-screen mode as illustrated in (b) of FIG. 6, the page display area A″ is displayed throughout the screen. The page full-screen mode is different from the normal page viewing mode in that an enlargement region that is currently selected is marked.

Further, in the page full-screen mode, it is possible to carry out operations similar to those carried out in the page display area A″ in the column viewing mode. For example, in the page full-screen mode, it is possible to carry out (i) a flicking operation in the horizontal direction so as to carry out page switching, (ii) a tapping operation so as to specify an enlargement region, and (iii) other operations.

In the column full-screen mode and the page full-screen mode, it is possible to an operation of switching between the column full-screen mode and the page full-screen mode, as well as an operation of switching to the column viewing mode. Note that an operation method for switching modes in this manner is not limited to a specific one.

For example, in the column viewing mode, switching to the column full-screen mode may be carried out by double tapping in the column display area B″, and switching to the page full-screen mode may be carried out by double tapping in the page display area A″. Further, in each of the column full-screen mode and the page full-screen mode, switching back to the column viewing mode may be carried out by double tapping on the screen.

Further, for example, in the column viewing mode, a transition to the column full-screen mode may be made by a pinching-out operation in the column display area B″, and a transition to the page full-screen mode may be made by a pinching-out operation in the page display area A″. In the page full-screen mode or the column full-screen mode, a transition back to the column viewing mode may be made by a pinching-in operation.

[Displaying Related Information (Note)]

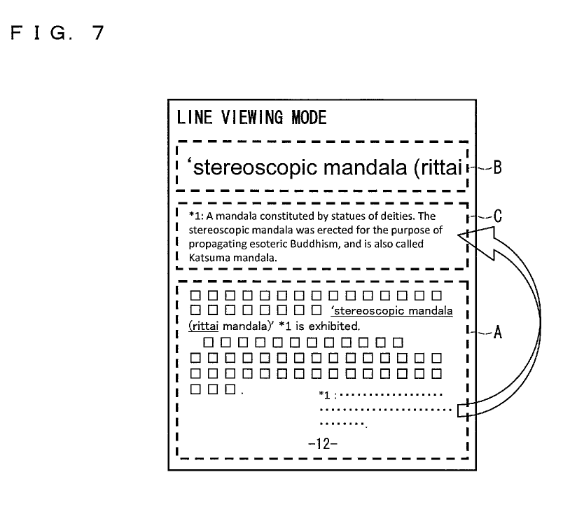

As described above, the electronic book reader 1 is capable of displaying related information of document content. The following description will discuss, with reference to FIG. 7, how the related information is displayed. FIG. 7 is a view illustrating an example of a screen in which a note is displayed as the related information.

When specifying an operation such as specifying an enlargement region or scrolling brings about a state in which a character string that indicates a presence of a note is present in or near an enlargement region, a related information display area C appears, as illustrated in FIG. 7, between the line display area B and the page display area A, and the note is displayed in the related information display area C.

Specifically, corresponding to “*1” which follows “‘stereoscopic mandala (rittai” in the page display area A, a note for “*1” written in a lower right part of the same page display area A is displayed in the related information display area C. According to this, while viewing text displayed in an enlarged manner in the line display area B, the user can check, in the related information display area C, a note which is related to the text.

In the example illustrated in FIG. 7, a note that is present on a page which is currently displayed in an enlarged manner is displayed. Note, however, that a page on which an image of a note (i.e., a related image) is present may be different from a page which is currently displayed in an enlarged manner. Further, a trigger for displaying a note is not limited to the example. For example, it is possible to employ a configuration in which a note is displayed when text which is displayed in an enlarged manner is tapped in a state where a character string or a sign (e.g., “*”) for referring to the note is included in the text. It is also possible to employ a configuration in which a note is displayed when a character string or a sign for referring to the note is tapped in the page display area in a state where the character string or the sign for referring to the note is included in text which is displayed in an enlarged state.

[Displaying Related Information (Drawing)]

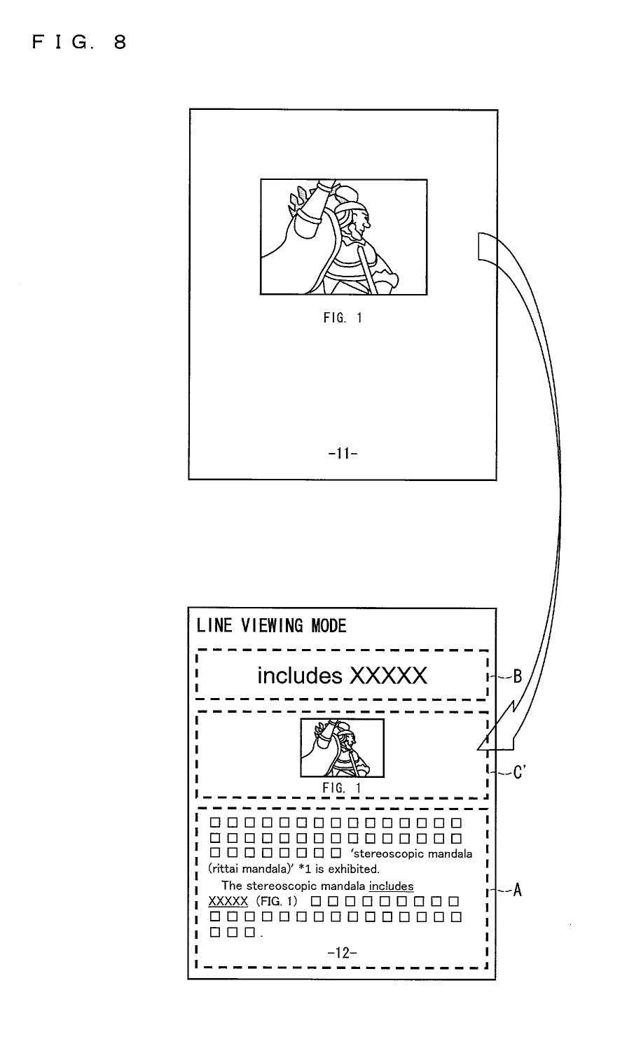

In the example illustrated in FIG. 7, the note is displayed as the related information. The electronic book reader 1 is also capable of displaying a drawing as the related information. This will be described with reference to FIG. 8. FIG. 8 is a view illustrating an example of a screen in which a drawing is displayed as the related information.

The timing at which a drawing is displayed as the related information is, as in the case of displaying the note as the related information, when an operation such as specifying an enlargement region or scrolling brings about a state where “FIG. . . . ” is present in or near an enlargement region. When such a state is brought in, a related information display area C′ appears, as illustrated in FIG. 8, between the line display area B and the page display area A, and a thumbnail image of the drawing is displayed in the related information display area C′.

Specifically, text which reads “xxxxx included” is displayed in an enlarged manner in the line display area B. The text and “FIG. 1” are displayed in the page display area A so that “FIG. 1” follows the text. A thumbnail image of FIG. 1, which is displayed in a previous page (page 11), is displayed in the related information display area C′. According to this, while viewing text displayed in an enlarged manner in the line display area B, the user can check, in the related information display area C′, a drawing that is related to the text, without returning to the previous page.

[Transition to Display State of Related Information (Drawing)]

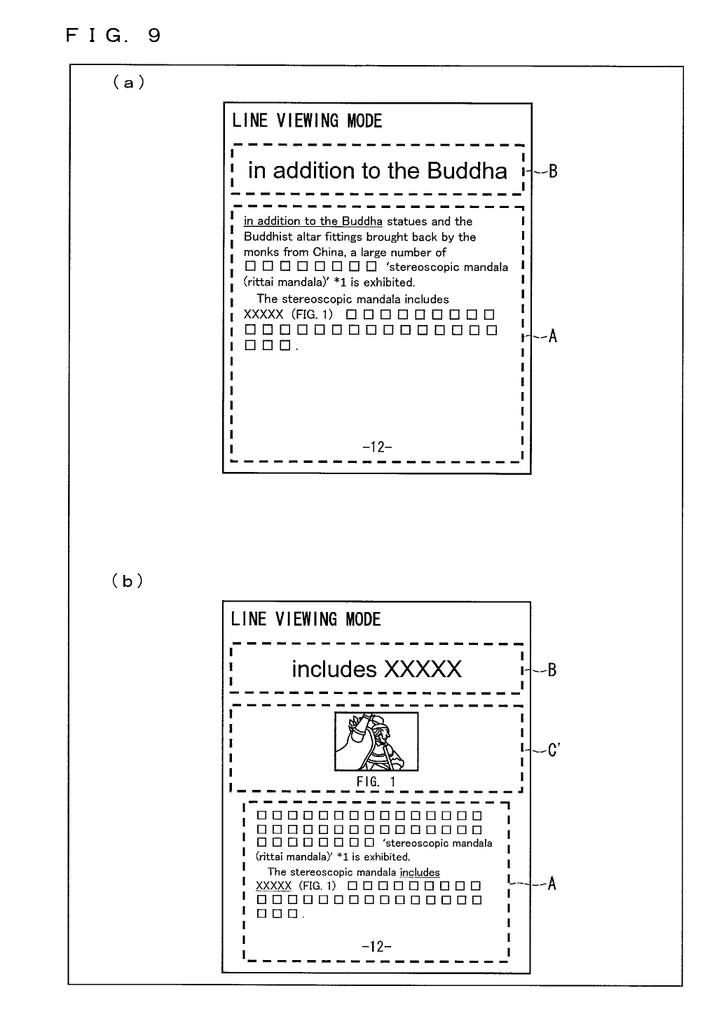

Next, the following description will discuss, with reference to FIG. 9, a screen transition which is made when the related information is displayed. FIG. 9 is a view illustrating a screen transition which is made when related information is displayed. (a) of FIG. 9 illustrates an example of a screen in a state before the related information is displayed, and (b) of FIG. 9 illustrates an example of a screen in a state after a drawing is displayed as the related information.

As illustrated in (a) and (b) of FIG. 9, when the drawing is displayed as the related information, the related information display area C′ appears, in response to which the image of the page display area A is reduced. As a matter of course, it is not necessary to reduce the image of the page display area A in a case where it is possible to display the drawing in the related information display area C′ without reducing the image of the page display area A.

Further, FIG. 1 is displayed in a maximum possible size that can be displayed within the related information display area C′. Since an original size (a size of the image displayed on page 11) of FIG. 1 exceeds the maximum possible size that can be displayed within the related information display area C′, FIG. 1 is displayed in a reduced manner.

In the example illustrated in FIGS. 8 and 9, the drawing is displayed in the related information display area C′ in a state where the page display area A is displayed. Note, however, that it is possible to employ a configuration in which the line display area B and the related information display area C′ are displayed and the page display area A is not displayed. In this case, the drawing can be displayed in a larger size.

However, since displaying the page display area A together allows the user to check the enlarged document and the drawing while referring to a display layout of the page, it is preferable to display the page display area A unless characters are reduced to an extent that the characters cannot be recognized at all.

[Details of Line Management Information]

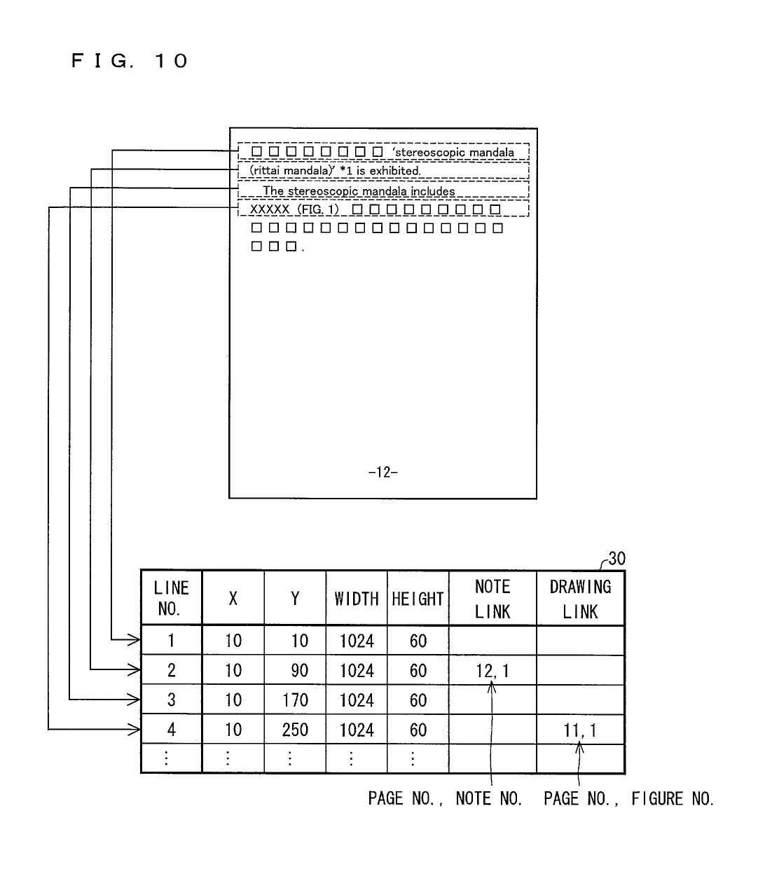

Next, the following description will discuss, with reference to FIG. 10, details of the line management information 30 for carrying out displaying in the above-described manners. FIG. 10 is a view illustrating the line management information 30. The line management information 30 illustrated in FIG. 10 is information in a table format in which the following seven elements: line number (line No.), X, Y, width, height, note link, and drawing link are associated with one another.

A line number is a number which is assigned to each line of text written on a page. FIG. 10 illustrates an example case in which numbers, starting from one (1), are sequentially assigned to respective pages. In this case, line management information 30 as one illustrated in FIG. 10 is stored for each page, and the line management information is associated with information (not shown) which indicates a page corresponding to the line management information 30. Note that the line numbers may be assigned to respective lines of single document content sequentially from the first line of the document content. In this case, single line management information 30 is provided per document content.

X and Y are information that indicates a position of a line. In the example illustrated in FIG. 10, X and Y are coordinate values that indicate a position of an upper left apex of a rectangular shape of a line relative to an origin (0,0) which is located at an upper left corner of a screen. For example, an X value and a Y value of a line with a line number one (1) indicate that the line has coordinate values (10,10). Note that coordinate values correspond to the number of dots in the screen. For example, a point having coordinate values (10,10) is the tenth dot to the right from the upper left corner of the screen and the tenth dot to the bottom from the upper left corner of the screen.

Width and height are information which indicates a size of a line. In the example illustrated in FIG. 10, a width and a height indicate the number of dots. For example, FIG. 10 shows that the line with the line number one (1) has a size with a width of 1024 dots and a height of 60 dots. A position (an area occupied by a line in the screen) of a line is specified by values of X, Y, width, and height.

For example, it is specified that the line with the line number one (1) has an upper left apex with coordinate values (10,10) and a size with a width of 1024 dots and a height of 60 dots. It is thus specified that the line occupies a rectangular region defined by opposite apexes (10,10) and (1034,70) on the screen.

Note link and drawing link are information for referring to related information. A note link specifies a note in the form of “page number, note number”, and a drawing link specifies a note in the form of “page number, figure number”.

Associating the link information with a line in this manner allows related information to be displayed before “FIG. . . . ” or “* . . . ” enters an enlargement region, as in the example illustrated in FIGS. 7 through 9. As a matter of course, the timing for displaying the related information can be appropriately determined by, for example, a person who creates content. An object with which the link information is to be associated is not limited to an entire line. For example, a single line may be divided into a plurality of regions, each of which is then associated with link information. Alternatively, link information may be associated with a region in a line in which region “FIG. . . . ” or “* . . . ” is written.

Note that the note link and the drawing link are not limited to the above-described example, as long as they are information which allows uniquely specifying a note and a drawing, respectively. Since a drawing is referred to in the same manner as a note is, the note link and the drawing link may be provided integrally as single link information.

Further, the line management information 30 is not limited to one in a table format, as long as it allows specifying a region of each line constituting the document content. In a case where it is not necessary to display any related information, the elements ‘note link’ and ‘drawing link’ may be omitted. The note link and the drawing link may be information which is independent of the line management information 30.

Although the above description has described an example in which the line management information 30 is horizontally written document content, the above description similarly applies to a configuration in which the line management information 30 is vertically written document content. Line management information 30 of document content which is made up of columns may be, as with the line management information 30 of the horizontally written document content, information in which each column is associated with (i) coordinate values (X,Y) indicative of a position of the each column, (ii) a width of the each column, and (iii) a height of the each column.

Further, since text of the document content made up of columns is vertically written, the line management information 30 of the document content made up of columns may be, as with the line management information 30 of the vertically written document content, information in which each line is associated with (i) coordinate values (X,Y) indicative of a position of the each line, a width of the each line, and a height of the each line. Note that a case in which the line management information 30 is information indicative of a position of each column has an advantage that an amount of the information can be reduced as compared with a case in which the line management information 30 is information indicative of a position of each line.

[Details of Related Information Position List]

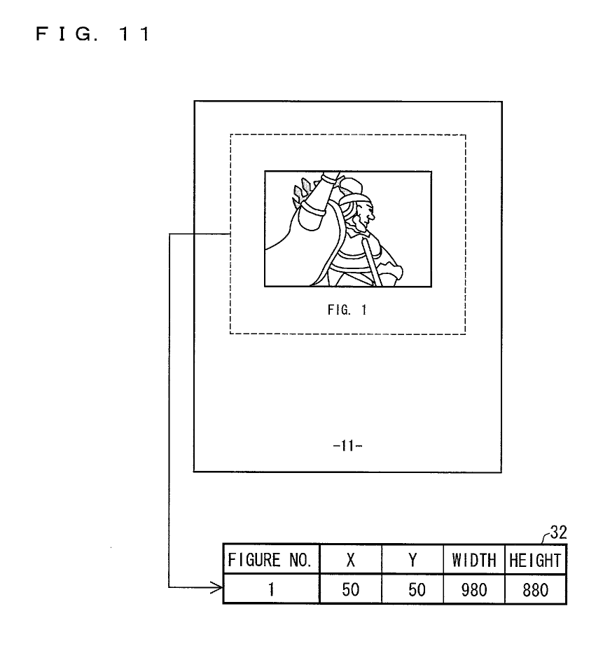

Next, the following description will discuss, with reference to FIG. 11, details of the related information position list 32 for displaying related information. FIG. 11 is a view illustrating the related information position list 32. The related information position list 32 illustrated in FIG. 11 is information in a table format in which the following five elements: figure number (figure No.), X, Y, width, and height are associated with one another.

A figure number is a number which is associated with each drawing included in document content. The figure number is simply required to allow uniquely specifying each drawing that is to be displayed as related information. For example, FIG. 1 may be assigned a figure number one (1), and drawings which follow FIG. 1 may be sequentially assigned numbers.

X and Y are information which indicates a position of a drawing. In an example illustrated in FIG. 11, X and Y indicate coordinate values of an upper left apex of a rectangular in which a drawing is contained. For example, in the example illustrated in FIG. 11, an X value and a Y value indicate that the coordinate values are (50,50).

Width and height are information which indicates a size of a drawing. In the example illustrated in FIG. 11, a width and a height indicate the number of dots. For example, in the example illustrated in FIG. 11, it is shown that the drawing has a size with a width of 980 dots and a height of 880 dots. That is, it is specified that “FIG. 1” occupies, on page 11, a rectangular region that is defined by an upper left apex (50,50) and an apex (1030,930) opposite to the upper left apex.

When the related information is to be displayed, the related information position list 32 as described above is referred to, so that a position of the drawing indicated by the drawing link in the line management information 30 is specified. Then, an image corresponding to the position is cut out and displayed in a size to which the image is reduced so as to fit in the related information display area C′.

Note that, although FIG. 11 illustrates related information position list 32 of a drawing, related information position list 32 of a note can be displayed with use of a similar list. However, since a note generally has characters of a size equal to or smaller than that of characters of main text, it is preferable that an image cut out with use of the list be displayed by being reduced to a maximum possible size that allows the image to fit in the related information display area, as in the example illustrated in FIG. 7.

Although the present embodiment has described a drawing and a note as specific examples of the related information, the related information is not limited to these examples as long as it provides a certain merit to the user by being presented together with an enlarged document. For example, a table may be displayed as the related information.

[Flow of Enlarged Display Process]

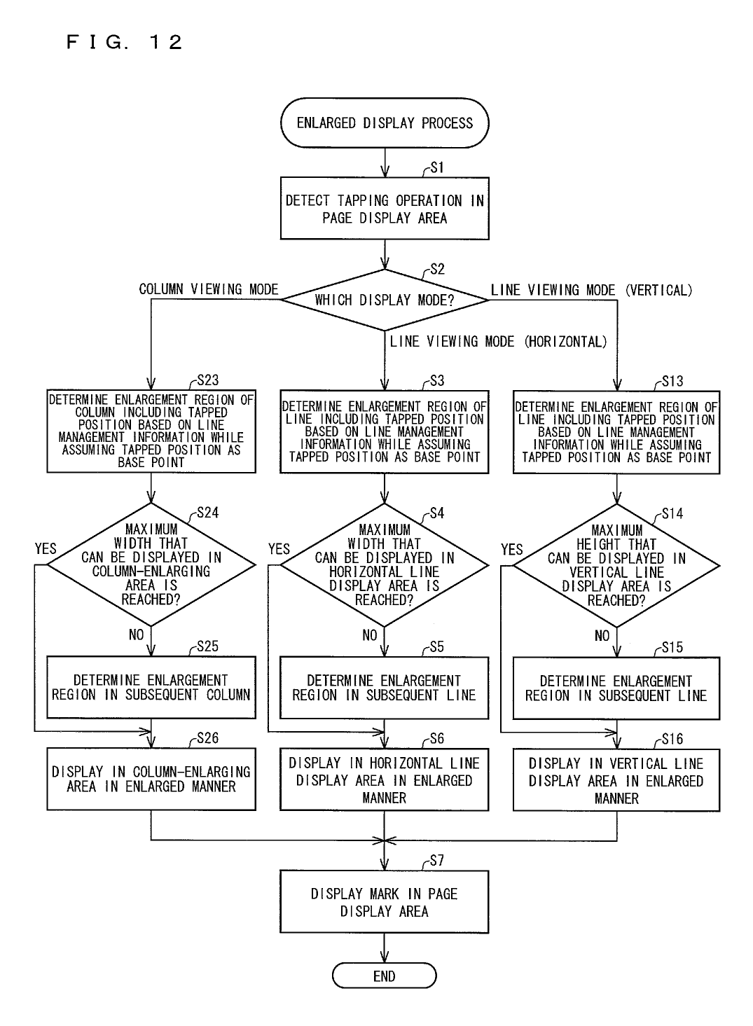

Next, the following description will discuss, with reference to FIG. 12, a flow of an enlarged display process carried out when the electronic book reader 1 carries out enlarged display. FIG. 12 is a flowchart showing an example of the enlarged display process.

In a case where the user carries out a tapping operation in the page display area, information indicative of coordinates of a tapped position is transmitted from the input section 10 to the enlargement region determining section 20. Then, the enlargement region determining section 20 detects, on the basis of the coordinates and a current viewing mode, the tapping operation carried out in the page display area (S1).

Note that the viewing mode is checked because an arrangement of the page display area may be changed depending on the viewing mode. The viewing mode can be specified with use of line management information 30 corresponding to the content 31 to be displayed.

For example, a line of a vertically written document has a height with a value greater than that of a width of the line, and a line of a horizontally written document has a width with a value greater than that of a height of the line. As such, it is possible to specify, on the basis of a ratio of a width and a height of a line, a viewing mode in which a document should be displayed. Further, in a case of a document made up of columns, a ratio of a width and a height of a column is different from a ratio of a width and a height of a line. This can be made use of to display the document made up of columns in the column viewing mode. Further, information which indicates a viewing mode to be applied may be included in the line management information 30. It is also possible to cause the user to select a viewing mode to be applied.

A subsequent process varies depending on the display mode (viewing mode) at the time of detecting the tapping operation. That is, in a case where the viewing mode is a line viewing mode for a horizontally written document (line viewing mode (horizontal) at S2), the enlarged display process proceeds to S3. In a case where the viewing mode is a line viewing mode for a vertically written document (line viewing mode (vertical) at S2), the enlarged display process proceeds to S13. In a case where the viewing mode is a column viewing mode (column viewing mode at S2), the enlarged display proceeds to S23.

At S3, the enlargement region determining section 20 determines, on the basis of the line management information 30 and while assuming the tapped position as a reference, an enlargement region of a line that includes the tapped position. Specifically, the enlargement region determining section 20 first determines a maximum width of a region to be enlarged that can be displayed within the line display area for a horizontally written document. Note that the maximum width is determined by a width and a zooming of the line display area. For example, in a case where the width and the zooming of the line display area are 980 dots and 2X, respectively, the maximum width of the region to be enlarged is 490 dots.

Next, the enlargement region determining section 20 reads out, from the storage section 13, the line management information 30 of a page that was displayed at the time of detecting the tapping operation, and specifies, with use of the coordinates received from the input section 10, which line includes the tapped position. Then, the enlargement region determining section 20 specifies, in the specified line, an enlargement region within the maximum width, while assuming that an X value of the coordinates is a reference.

For example, in a case where the coordinates received from the input section 10 are (200,100), referring to the line management information 30 in FIG. 10 allows specifying that the tapped position is in a line with a line number 2. Then, the enlargement region is determined to be a region which extends to a position calculated by adding the maximum width to 200, which is an X value of the coordinates. For example, in a case where the maximum width is 490 dots, it is determined that a position of the enlargement region in the lateral direction extends from 200 to 690 (200+490). Then, it is determined that a position of the enlargement region in a height direction (vertical direction) extends from 90, which is a Y coordinate value shown in the line management information 30, to 150, which is a value calculated by adding a height value 60 to the Y coordinate value. That is, in this case, the enlargement region is determined to be a region extending from (200,90) to (690,150).

Note that the user is likely to carry out a tapping operation with respect to a character that is difficult to read. As such, it can be assumed that, in a case where an X coordinate of a tapped position which has been detected is a starting point of the enlargement region, a part (on the left) of a character which the user wants to enlarge does not fit in the enlargement region. It is therefore preferable that the starting point of the enlargement region be a position that is shifted leftward from the X coordinate of the tapped position which has been detected.

Subsequently, the enlargement region determining section 20 determines whether or not the enlargement region specified at S3 has reached the maximum width (S4). For example, in a case where, as in the above-described example, the tapped position is (200,100) and the maximum width is 490 dots, enlargement region extends up to 690 dots. In this case, the enlargement region determining section 20 determines that the enlargement region has reached the maximum width because the enlargement region extending up to 690 dots is entirely included in the line, since an X coordinate of a position at which the line starts is 10 and a width of the line is 1024. On the other hand, in a case where the tapped position is (900,100), the enlargement region determining section 20 determines that the enlargement region has not reached the maximum width because there are still 356 dots left until the maximum width is reached, since a region not exceeding 1034 dots can be allowed to be determined as the enlargement region in the line.

In a case where the enlargement region determining section 20 determines that the enlargement region has not reached the maximum width (NO at S4), the enlarged display process proceeds to a process of S5. On the other hand, in a case where the enlargement region determining section 20 determines that the enlargement region has reached the maximum width (YES at S4), the enlarged display process proceeds to a process of S6 without carrying out the process of S5.

At S5, the enlargement region determining section 20 determines an enlargement region in a subsequent line. Specifically, the enlargement region determining section 20 determines the enlargement region of the subsequent line to be a region which extends, until the maximum width is reached, from a left end of a line in the line management information 30 which line has a line number obtained by adding 1 to the line number of the line including the tapped position.

That is, in a case where the enlargement region determined at S3 has reached an end of the line including the tapped position, the enlargement region determining section 20 further determines an enlargement region that starts at a head of the subsequent line and extends within a region that can be displayed in an enlarged manner in the line display area.

For example, in a case where there are still 356 dots left until the maximum width is reached, the enlargement region determining section 20 determines the enlargement region to be a region extending from the head X=10 of the subsequent line to X=366, which is 356 dots to the right from X=10. Further, the enlargement region determining section 20 refers to the line management information 30 so as to determine a position of the enlargement region in the height direction (vertical direction). In this way, the enlargement region of the subsequent line is determined.

At S6, the enlargement region determining section 20 gives the display processing section 21 a command to display, in the line display area, an image of an enlargement region which has been determined in a manner as described above. Upon reception of the command, the display processing section 21 reads out the image of the enlargement region determined, and enlarges the image at a predetermined zooming so as to display the enlarged image in the line display area for a horizontally written document.

Note that, in a case where the enlargement region extends over two lines, the display processing section 21 may display an image of a preceding line in an enlarged manner in the line display area, and then display an image of a subsequent line in an enlarged manner in the line display area so as to follow the enlarged image of the preceding line. The display processing section 21 may also create an image in which an image of a preceding line and an image of a subsequent line are connected, and then display the created image in an enlarged manner in the line display area. That is, it is simply required that (i) an enlarged image corresponding to a preceding line and an enlarged image corresponding to a subsequent line are arranged in this order and (ii) the enlarged images of enlargement regions of the respective two lines are connected. Details of a specific operation carried out for carrying out displaying in this manner are not particularly limited.

Note that, in a case of having no space which serves as the line display area at the time of carrying out enlarged display, space may be secured by moving the page display area or reducing the page display area so as to carry out the enlarged display.

Further, the enlargement region determining section 20 notifies the display processing section 21 of the enlargement region determined, and gives the display processing section 21 a command to display a mark in the page display area. Upon reception of the notification and the command, the display processing section 21 displays a mark so that an image of the enlargement region, which the display processing section 21 has been notified of, can be distinguished from the other image (S7).

For example, the enlargement region may be underlined as illustrated in (b) of FIG. 2, or a background color of the entire enlargement region may be changed as illustrated in FIG. 5. Note that, in a case where the position of the page display area was moved or the page display area was reduced at the time of displaying the enlargement region in the line display area, the enlargement region which the display processing section 21 has been notified of is corrected before a marking process is carried out.

Next, the following description will discuss a process carried out in the line viewing mode for a vertically written document. In a case where the display mode is the line viewing mode for a vertically written document at S2, the enlarged display process proceeds to S13. At S13, an enlargement region is determined with use of coordinates of a tapped position and line management information 30, in the same manner as at S3. Note, however, that the enlargement region is determined on the basis of a height of a line, since the line display area is also for a vertically written document (see FIG. 4) in the case of the line viewing mode for a vertically written document.

That is, the enlargement region determining section 20 determines whether or not the enlargement region determined at S13 has reached a maximum height (S14). In a case where the enlargement region determining section 20 determines that the enlargement region determined at S13 has not reached the maximum height (NO at S14), the enlarged display process proceeds to a process of S15. In a case where the enlargement region determining section 20 determines that the enlargement region determined at S13 has reached the maximum height (YES at S14), the enlarged display process proceeds to a process of S16 without carrying out the process of S15.

At S15, the enlargement region determining section 20 determines an enlargement region of a subsequent line. Specifically, the enlargement region determining section 20 determines the enlargement region of the subsequent line to be a region which extends, until the maximum height is reached, from an upper end of a line in the line management information 30 which line has a line number obtained by adding 1 to the line number of the line including the tapped position. For example, in a case where there are still 356 dots left until the maximum height is reached in a state where the enlargement region of the preceding line has been determined, a height of the enlargement region of the subsequent line will be from the upper end Y=10 of the subsequent line to Y=366, which is 356 dots to the bottom from the upper end Y=10.

At S16, the enlargement region determining section 20 gives the display processing section 21 a command to display, in the line display area for a vertically written document, an image of the enlargement region which has been determined in a manner as described above. Upon reception of the command, the display processing section 21 reads out the image of the enlargement region determined, and enlarges the image at a predetermined zooming so as to display the enlarged image in the line display area for a vertically written document. Subsequently, the enlarged display process proceeds to S7.

Next, the following description will discuss a process carried out in the column viewing mode. In a case where the display mode is the column viewing mode at S2, the enlarged display process proceeds to S23. At S23, an enlargement region is determined in the same manner as at S3. For example, in a case where the line management information 30 manages the content 31 on a column-by-column basis, the enlargement region is determined to be a region which extends rightward from an X coordinate of a tapped position until the region reaches a maximum width. In a case where the line management information 30 manages the content 31 on a line-by-line basis, the enlargement region is determined to be a region which extends rightward from an X coordinate of a line including a tapped position until the region reaches a maximum width.

Subsequently, the enlargement region determining section 20 determines whether or not the enlargement region determined at S23 has reached a maximum width (S24). In a case where the enlargement region determining section 20 determines that the enlargement region determined at S23 has not reached the maximum width (NO at S24), the enlarged display process proceeds to a process of S25. In a case where the enlargement region determining section 20 determines that the enlargement region determined at S23 has reached the maximum width (YES at S24), the enlarged display process proceeds to a process of S26 without carrying out the process of S25.

At S25, the enlargement region determining section 20 determines an enlargement region of a subsequent column. For example, in a case where the line management information 30 manages the content 31 on a column-by-column basis, the enlargement region determining section 20 determines the enlargement region of the subsequent column to be a region which extends, until the maximum width is reached, from a left end of a column in the line management information 30 which column has a column number obtained by adding 1 to the column number of the column including the tapped position. In a case where the line management information 30 manages the content 31 on a line-by-line basis, the enlargement region determining section 20 determines the enlargement region to be a line that fits in the maximum width, on the basis of (i) the number of dots left until the maximum width is reached, (ii) an X coordinate of a position of each line indicated by the line management information 30, and (iii) a width of the each line indicated by the line management information 30.

At S26, the enlargement region determining section 20 gives the display processing section 21 a command to display, in the column display area, an image of the enlargement region which has been determined in a manner as described above. Upon reception of the command, the display processing section 21 reads out the image of the enlargement region determined, and enlarges the image at a predetermined zooming so as to display the enlarged image in the column display area. Subsequently, the enlarged display process proceeds to S7.

[Flow of During-Enlargement Process]

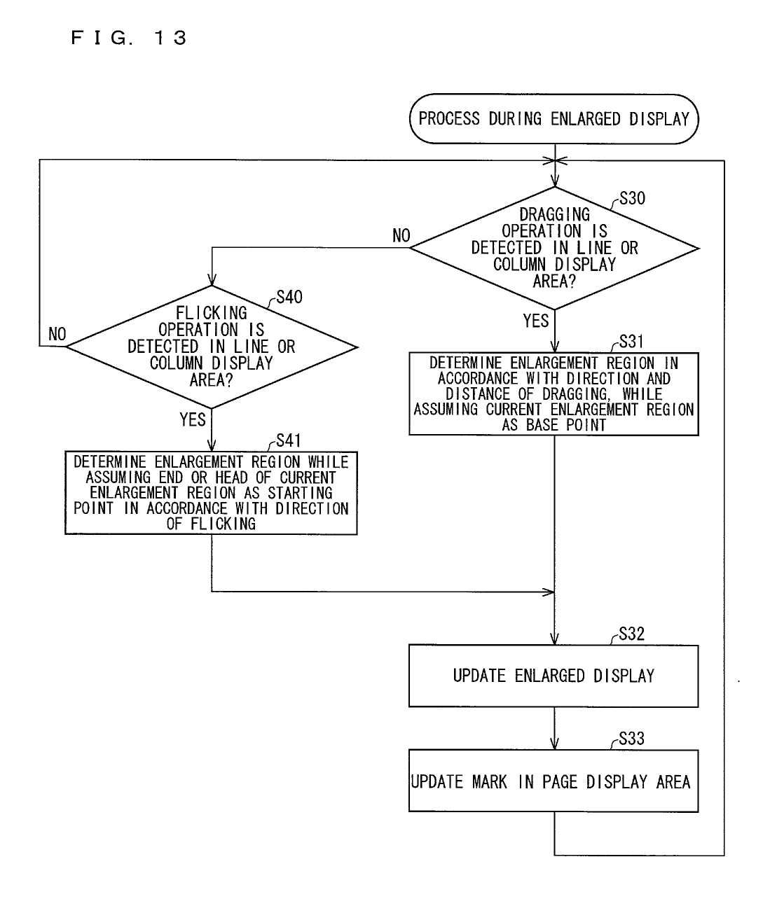

Next, the following description will discuss, with reference to FIG. 13, a flow of a during-enlargement process which is carried out while document content is displayed in an enlarged manner. FIG. 13 is a flowchart showing an example of the during-enlargement process.

The enlargement region determining section 20 detects, while the document content is displayed in an enlarged manner, a dragging operation in the line display area or the column display area (S30). In a case where the enlargement region determining section 20 detects, on the basis of an input operation received by the input section 10, the dragging operation in the line display area or the column display area (YES at S30), the during-enlargement process proceeds to a process of S31. On the other hand, in a case where the enlargement region determining section 20 detects no dragging operation (NO at S30), the during-enlargement process proceeds to a process of S40.

At S31, the enlargement region determining section 20 determines an enlargement region in accordance with a direction and a distance of the dragging operation. Specifically, the enlargement region determining section 20 determines to cause a position of a current enlargement region to move leftward in a case where the dragging operation is carried out rightward, and to move the position of the current enlargement region to move rightward in a case where the dragging operation is carried out leftward.

Further, the enlargement region determining section 20 determines a moving distance in accordance with the distance of the dragging operation so that characters which are displayed in an enlarged manner follow a finger with which the user carries out the dragging operation. Then, the enlargement region determining section 20 instructs the display processing section 21 to display the enlargement region in an enlarged manner, a position of which has been moved in the determined moving direction and by the determined moving distance. The enlargement region determining section 20 thus updates what is displayed in an enlarged manner (S32).

Note that the position of the enlargement region is moved between lines. That is, in a case where the position of the enlargement region has been moved to an end of a line, the enlargement region determining section 20 causes the position of the enlargement region to move to a head of a subsequent line. In a case where the position of the enlargement region has been moved to a head of a line, the enlargement region determining section 20 causes the position of the enlargement region to move to an end of a preceding line. It is also possible to refer to line management information 30 of each page so as to cause the position of the enlargement region to move between pages.

Then, the enlargement region determining section 20 gives the display processing section 21 a command to update a mark displayed in the page display area (S33). Subsequently, the during-enlargement process returns to S30.

At S40, the enlargement region determining section 20 detects a flicking operation in the line display area or the column display area. In a case where the enlargement region determining section 20 detects, on the basis of the input operation received by the input section 10, the flicking operation in the line display area or the column display area (YES at S40), the during-enlargement process proceeds to a process of S41. On the other hand, in a case where the enlargement region determining section 20 detects no flicking operation (NO at S40), the during-enlargement process returns to the process of S30.

At S41, the enlargement region determining section 20 causes the position of the enlargement region to move in accordance with a direction of the flicking operation. Specifically, in a case where the flicking operation is carried out rightward, the enlargement region determining section 20 causes the position of the enlargement region to move so that a head of the current enlargement region becomes an end of a new enlargement region. In a case where the flicking operation is carried out leftward, the enlargement region determining section 20 causes the position of the enlargement region to move so that an end of the current enlargement region becomes a head of a new enlargement region. Subsequently, the during-enlargement process proceeds to S32 so as to update, on the basis of the enlargement region determined in an above-described manner, what is displayed in an enlarged manner. The during-enlargement process also updates a mark in the page display area (S33), and then returns to S30.

[Flow of Related Information Display Process]

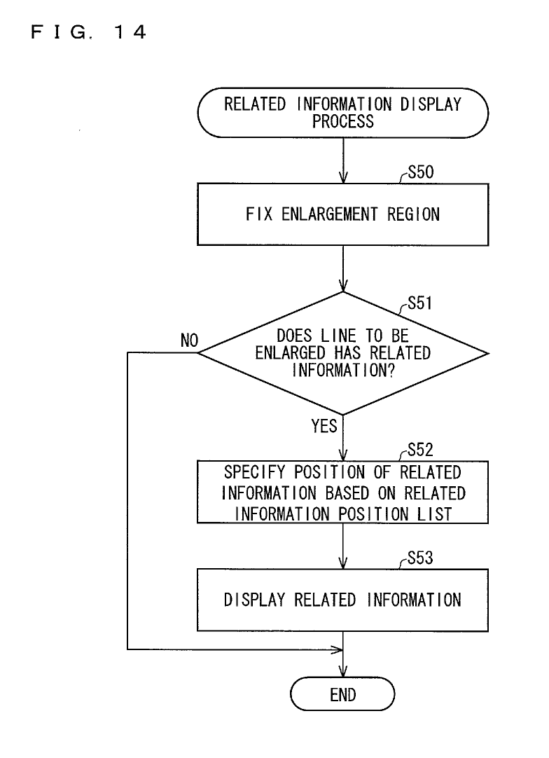

Next, the following description will discuss, with reference to FIG. 14, a flow of a related information display process for displaying content of a drawing, content of a note, or the like while document content is displayed in an enlarged manner. FIG. 14 is a flowchart showing an example of the related information display process. Note that the following description will discuss an example in which the related information display process is executed when an enlargement region is fixed.

When the enlargement region is fixed (S50), the enlargement region determining section 20 notifies the related information processing section 22 of information indicative of the enlargement region which has been fixed. Note that the information is simply required to allow specifying a line in which the enlargement region is present. For example, the information may be a line number.

Upon reception of the notification, the related information processing section 22 checks whether or not a line to be enlarged has related information (S51). Specifically, the related information processing section 22 refers to line management information 30 so as to check whether or not the line to be enlarged is associated with link information (a note link or a drawing link in the example illustrated in FIG. 10).

In a case where the related information processing section 22 checks that the line to be enlarged has no related information (NO at S51), the related information processing section 22 finishes the related information display process. On the other hand, in a case where the related information processing section 22 checks that the line to be enlarged has related information (YES at S51), the related information processing section 22 refers to the related information position list 32 so as to specify a position of an image (related image) corresponding to the related information (S52). Then, the related information processing section 22 instructs the display processing section 21 to display the image at the specified position (S53), and finishes the related information display process.

[Automatic Scrolling]

In the example described above, what is displayed in an enlarged manner is scrolled by a flicking operation and by a dragging operation in the line display area B. Note, however, that what is displayed in an enlarged manner may be automatically scrolled. This makes it possible to read through a document displayed in the line display area B without repeating a dragging operation and a flicking operation.

An operation for starting automatic scrolling is not particularly limited. For example, the scrolling may be started by a flicking operation. In this case, the scrolling may be carried out (i) in a direction in which the flicking operation was carried out and (ii) at a speed in accordance with a distance (a length of a trajectory of a finger on the screen) of the flicking operation. Further, the scrolling may be stopped by touching text which is being scrolled.

[Creation of Line Management Information]

The above description has discussed an example in which enlarged display or the like are carried out with use of line management information 30 which has been stored in advance in the storage section 13. Note that it is possible to employ a configuration in which the electronic book reader 1 creates line management information 30 by analyzing the content 31, and carries out enlarged display or the like with use of the line management information 30 thus created. This makes it possible to carry out enlarged display or the like across lines and columns, even in a case where no line management information 30 for the content is provided by, for example, a person who has created the content.

The line management information 30 is simply required to allow specifying a position of a line or a column constituting the content 31. As such, the analysis of the content is also simply required to have such a precision as to allow specifying a position of a line or a column constituting the content 31. The analysis of the content therefore does not necessarily have to involve character recognition.

Note that, in a case where characters are recognized through the analysis, the recognized characters may be used to create link information (a note link or a drawing link of FIG. 10) for referring to related information, and may be used to further create related information position list 32. For example, in a case where a character string “FIG. 1” is detected from the recognized characters, a drawing link of “FIG. 1” may be associated with a line which includes the character string in the line management information 30. Then, a page (page 11 in the example illustrated in FIG. 11) on which the character string “FIG. 1” is independently (without being preceded or followed by any other character strings) written may be detected, and related information position list 32 may be created with respect to a region of “FIG. 1” which is defined as a region other than a blank part of the page.

[Enlarged Display of a Plurality of Lines]

The above description has discussed an example in which the line display area is made up of a single line. Note, however, that the line display area may be made up of a plurality of lines. In this case, the same process as that carried out for displaying document content in an enlarged manner in the single line display area may be carried out with respect to each of the plurality of lines in the line display area.

The present invention is not limited to the above-described embodiments but allows various modifications within the scope of the claims. In other words, any embodiment derived from a combination of two or more technical means appropriately modified within the scope of the claims will also be included in the technical scope of the present invention.

[Configuration Example Realized by Software]

Lastly, each block of the electronic book reader 1, especially the control section 12, can be (i) realized by means of hardware by use of logic circuits provided on an integrated circuit (IC chip) or (ii) realized by means of software by use of a CPU (Central Processing Unit).

In the latter case, the electronic book reader 1 includes a CPU for executing commands of a program for implementing each function, a ROM (Read Only Memory) in which the program is stored, a RAM (Random Access Memory) on which the program is loaded, a storage device (recording medium), such as a memory, in which the program and various data are stored, and the like. An object of the present invention can be attained by the following procedures (i) and (ii): (i) loading, to the electronic book reader 1, the recording medium, in which program code (an executable program, an intermediate code program, and a source program) of the control program (software for implementing the functions) of the electronic book reader 1 is recorded so as to be read out by a computer and (ii) causing the computer (or a CPU or an MPU) to read out and execute the program code recorded in the recording medium.

For example, a tape such as a magnetic tape or a cassette tape, a disk including (i) a magnetic disk such as a Floppy (Registered Trademark) disk or a hard disk and (ii) an optical disc such as a CD-ROM, an MO, an MD, a DVD, or a CD-R, a card such as an IC card (including a memory card) or an optical card, a semiconductor memory such as a mask ROM, an EPROM, an EEPROM, or a flash ROM, a logic circuit such as a PLD (Programmable Logic Device) or an FPGA (Field Programmable Gate Array), or the like can be used as the recording medium.

Further note that the electronic book reader 1 can be configured so as to be capable of being connected to a communications network via which the program code is loaded to the electronic book reader 1. The communications network is not limited to a specific one as long as the communications network can transfer the program code. The communications network can be, for example, an internet, an intranet, an extranet, a LAN, an ISDN, a VAN, a CATV communications network, a virtual private network, a telephone network, a mobile telecommunications network, a satellite communication network or the like. A transmission medium that constitutes the communications network is not limited to a specific one as long as the transmission medium is a medium that can transfer the program code. The examples of the transmission medium encompass (i) wired communications such as IEEE1394, USB, a power-line carrier, a CATV line, a telephone line, or ADSL (Asymmetric Digital Subscriber Line) and (ii) wireless communications such as infrared communication by means of IrDA or remote control, Bluetooth (Registered Trademark), IEEE802.11 wireless, HDR (High Data Rate), NFC (Near Field Communication), DLNA (Digital Living Network Alliance), a mobile phone network, a satellite circuit, or a terrestrial digital network. Note that the present invention can be realized also by means of a computer data signal embedded in a carrier wave, which computer data signal is obtained by embodying the program code in electronic transmission.

### Points of the Invention

As described above, a display control device of the present invention includes: enlargement region determining means for (i) referring to management information indicative of positions of a plurality of lines so as to determine, by assuming that a position specified on document content is a reference, a region in a line including the position, the region serving as an enlargement region, and (ii), in a case where the enlargement region thus determined reaches an end of the line, further determining, as an extension of the enlargement region, a region in a subsequent line which region starts at a head of the subsequent line and fits in an enlarged-display area when displayed in an enlarged manner in the enlarged-display area; and enlarged display means for displaying an enlarged image of the enlargement region, which has been determined by the enlargement region determining means, in the enlarged-display area so that a part of the enlarged image which corresponds to the line including the position and a part of the enlarged image which corresponds to the subsequent line are arranged in this order.

The display control device preferably has a configuration in which, in a case where the document content is vertically written, the enlarged-display area in which the enlarged image is displayed in an enlarged manner by the enlarged display means is an area whose length direction corresponds to a vertical direction, and in a case where the document content is horizontally written, the enlarged-display area in which the enlarged image is displayed in an enlarged manner by the enlarged display means is an area whose length direction corresponds to a lateral direction.

According to the configuration, in a case where the document content is vertically written, the document content is displayed in an enlarged-display area whose length direction corresponds to a vertical direction, and in a case where the document content is horizontally written, the document content is displayed in an enlarged-display area whose length direction corresponds to a lateral direction.

Accordingly, the configuration allows the document content to be displayed in an enlarged manner and in an appropriate way that makes it easier for the user to view the document content, depending on whether the document content is vertically written or horizontally written. Note that whether the document content is vertically written or horizontally written may be determined on the basis of an input from the user, or determined depending on whether a length direction of a line constituting the document content is vertical or horizontal.

The display control device preferably has a configuration in which, in response to an input operation by a user, the enlargement region determining means causes a position of the enlargement region, which has been determined, to move between lines.

According to the configuration, in response to the input operation by the user, a position of the enlargement region which has been determined is caused to move between lines. This allows the user to read through text, which is displayed in the enlarged-display area, by causing the position of the enlargement region to move between lines.

The display control device preferably has a configuration in which the enlarged display means displays, together with an image of an entire page of the document content, the enlarged image of the enlargement region.

According to the configuration, the enlarged image of the enlargement region is displayed together with the image of the entire page of the document content. This makes it possible to view an enlarged image of a part of a page while checking a layout of the entire page.

The display control device preferably has a configuration in which the enlarged display means displays the enlargement region in the image of the entire page so that the enlargement region is distinguishable from the other part of the image of the entire page.

According to the configuration, the enlargement region is displayed in the image of the entire page so that the enlargement region is distinguishable from the other part of the image of the entire page. This allows the user to easily recognize which position of the layout of the entire page is being displayed in an enlarged manner.

It is preferable that the display control device further include related information processing means for (i) referring to (a) link information indicative of related information which is related to each of the plurality of lines of the document content and (b) image position information indicative of a position of a related image in the document content, the related image corresponding to the related information, (ii) reading out the related image related to a line determined as the enlargement region, and (iii) displaying the related image together with the enlarged image of the enlargement region.

According to the configuration, the link information and the image position information is referred to so that the related image related to the line determined as the enlargement region is read out and displayed together with the enlarged image of the enlargement region. That is, according to the configuration, an image related to the enlargement region is displayed together with the enlarged image of the enlargement region. This allows the user to view, on the same screen, a line and a related image which are related with each other, without carrying out any such operation as scrolling or switching pages.

Note that the display control device may be realized by use of a computer. In this case, (i) a control program for causing the computer to operate as each means of the display control device so as to realize the display control device by use of the computer and (ii) a computer-readable recording medium in which the control program is recorded, are also included in the scope of the present invention.

### INDUSTRIAL APPLICABILITY

The present invention is applicable to a device which displays page layout-type document content, a device which causes another display device to display the layout-type document content, and the like.

### REFERENCE SIGNS LIST

1: electronic book reader (display control device)
20: enlargement region determining section (enlargement region determining means)
21: display processing section (enlarged display means)
22: related information processing section (related information processing means)
30: line management information (management information, link information)
31: content (document content)
32: related information position list (image position information)

1. A display control device which displays document content made up of a plurality of lines and displays a section of the plurality of lines of the document content in an enlarged manner in a predetermined enlarged-display area, comprising:
enlargement region determining means for (i) referring to management information indicative of positions of the respective plurality of lines so as to determine, by assuming that a position specified on the document content is a reference, a region in a line including the position, the region serving as an enlargement region, and (ii), in a case where the enlargement region thus determined reaches an end of the line, further determining, as an extension of the enlargement region, a region in a subsequent line which region starts at a head of the subsequent line and fits in the enlarged-display area when displayed in an enlarged manner in the enlarged-display area; and
enlarged display means for displaying an enlarged image of the enlargement region, which has been determined by the enlargement region determining means, in the enlarged-display area so that a part of the enlarged image which corresponds to the line including the position and a part of the enlarged image which corresponds to the subsequent line are arranged in this order.

2. The display control device as set forth in claim 1, wherein:
in a case where the document content is vertically written, the enlarged-display area in which the enlarged image is displayed in an enlarged manner by the enlarged display means is an area whose length direction corresponds to a vertical direction; and
in a case where the document content is horizontally written, the enlarged-display area in which the enlarged image is displayed in an enlarged manner by the enlarged display means is an area whose length direction corresponds to a lateral direction.

3. The display control device as set forth in claim 1, wherein:
in response to an input operation by a user, the enlargement region determining means causes a position of the enlargement region, which has been determined, to move between lines.

4. The display control device as set forth in claim 1, wherein:
the enlarged display means displays, together with an image of an entire page of the document content, the enlarged image of the enlargement region.

5. The display control device as set forth in claim 4, wherein:
the enlarged display means displays the enlargement region in the image of the entire page so that the enlargement region is distinguishable from the other part of the image of the entire page.

6. A display control device as set forth in claim 1, further comprising related information processing means for (i) referring to (a) link information indicative of related information which is related to each of the plurality of lines of the document content and (b) image position information indicative of a position of a related image in the document content, the related image corresponding to the related information, (ii) reading out the related image related to a line determined as the enlargement region, and (iii) displaying the related image together with the enlarged image of the enlargement region.

7. A display control device which displays document content made up of a plurality of columns and displays a section of the plurality of columns of the document content in an enlarged manner in a predetermined enlarged-display area, comprising:
enlargement region determining means for (i) referring to management information indicative of positions of the respective plurality of columns so as to determine, by assuming that a position specified on the document content is a reference, a region in a column including the position, the region serving as an enlargement region, and (ii), in a case where the enlargement region thus determined reaches an end of the column, further determining, as an extension of the enlargement region, a region in a subsequent column which region starts at a head of the subsequent column and fits in the enlarged-display area when displayed in an enlarged manner in the enlarged-display area; and
enlarged display means for displaying an enlarged image of the enlargement region, which has been determined by the enlargement region determining means, in the enlarged-display area so that a part of the enlarged image which corresponds to the column including the position and a part of the enlarged image which corresponds to the subsequent column are arranged in this order.

8. A display method carried out by a display control device which displays document content made up of a plurality of lines and displays a section of the plurality of lines of the document content in an enlarged manner in a predetermined enlarged-display area,
the method comprising the steps of:
(i) referring to management information indicative of positions of the respective plurality of lines so as to determine, by assuming that a position specified on the document content is a reference, a region in a line including the position, the region serving as an enlargement region;
(ii) in a case where the enlargement region thus determined reaches an end of the line, further determining, as an extension of the enlargement region, a region in a subsequent line which region starts at a head of the subsequent line and fits in the enlarged-display area when displayed in an enlarged manner in the enlarged-display area; and
(iii) displaying an enlarged image of the enlargement region, which has been determined, in the enlarged-display area so that a part of the enlarged image which corresponds to the line including the position and a part of the enlarged image which corresponds to the subsequent line are arranged in this order.

9. (canceled)

10. A control program for causing a display control device recited in claim 1 to operate, the control program being configured to cause a computer to function as each of the means.

11. (canceled)
